(19) United States
(12) Patent Application Publication
(10) Pub. No.: US 2003/0132606 A1
(43) Pub. Date: Jul. 17, 2003

(54) Automatic extension tongue

(76) Inventor: Calvin K. Eskridge, Salem, OR (US)

Correspondence Address: Calvin Eskridge, 820 Teak Ct. S.E, Salem, OR, 97306, US

(21) Appl. No.: 10/046,049

(22) Filed: Jan. 15, 2002

(51) Int. Cl. B60P 3/10; B60D 1/36

(52) U.S. Cl. 280/482; 280/414.1; 280/491.2

(57) ABSTRACT

A boat trailer extension devise containing outside tube, inside tube, collar, travel pin, motor, gears and controls.

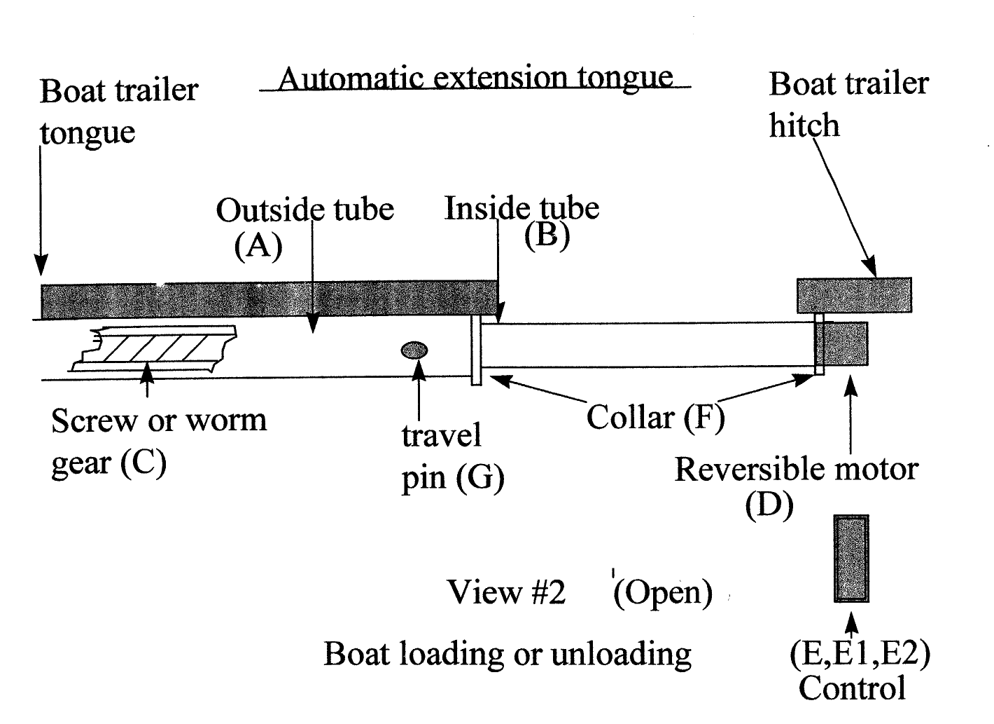

### BACKGROUND OF THE INVENTION

1. Field of the Invention

This invention relates to the trailer operation, specifically loading and unloading boats in water.

2. Background

Trailers typically are fixed frame and fixed tongue. The automatic extension tongue allows for an operation to move the boat further into deeper water, allowing it to float off with little or no effort.

### SUMMARY OF THE INVENTION

It Is therefore a first object of this invention to provide ease of loading and unloading by a single person or persons any watercraft that requires the use of a trailer.

It is a second object of this invention to keep the rear axle of the tow vehicle out of the water to protect the axle and wheel bearings.

According to the first aspect of the invention, a method for loading and unloading a boat to and from a trailer is provided. The method includes the steps of the mechanics of the automatic extension drive.

According to the second object of this invention, a method for protecting the trailer tow vehicles axles and bearings is a given.

Further objects, features, and advantages of the present invention will become apparent from the following description when taken in conjunct on with the accompanying drawing and claims.

### BRIEF DESCRIPTION OF THE DRAWING

The various advantages of the present invention will become apparent to one skilled in the art by reading the following specification and the subjoined claims and by referencing the following drawing in which:

View 1 is a closed or travel position of the trailer.

### DETAILED DESCRIPTION OF THE PREFERRED EMMBODIMENT OF THE INVENTION

Referring to View 1, there is shown the trailer extension tongue in the closed, or travel, position. Included is the outside tube (A) which accommodates the inner tube (B) and the screw or worm gear (C) with the attached reversible motor (D). Also shown is the control (E) either manual (E-1) or infra-red remote control (E-2). Included in View 1 is Stop Collar (F)and travel pin (G).

What is claimed is:

1) A method for ease of loading and unloading a boat into the water comprising the steps of:
providing a drive devise;
providing said gears, motors, tubes, collars, pins, bushings, bearings and controls remote or manual;
providing either manufactured in the trailer, or add on;
assembling devise.
